(19) United States
(12) Patent Application Publication
(10) Pub. No.: US 2008/0070082 A1
(43) Pub. Date: Mar. 20, 2008

(54) FUEL CELL

(76) Inventors: Yasuaki NORIMATSU, Hitachinaka (JP); Isao Ueno, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/680,037

(22) Filed: Feb. 28, 2007

(30) Foreign Application Priority Data
Sep. 20, 2006 (JP) 2006-254564

(51) Int. Cl. H01M 4/02

(52) U.S. Cl. 429/27

(57) ABSTRACT

A fuel cell comprising: a membrane electrode assembly; an anode current collector which lies near the anode of the membrane electrode assembly and collects electrons generated by the electrochemical reaction; a cathode current collector which lies near the cathode of the membrane electrode assembly and collects electrons consumed by the electrochemical reaction; a first end plate which surface-contacts the anode current collector and supplies the fuel to the anode; a second end plate which surface-contacts the cathode current collector and supplies the oxygen to the cathode; a pressing member which applies pressure to the first end plate and the second end plate to hold the membrane electrode assembly between the anode current collector and the cathode current collector; and an interconnect which is connected with the anode current collector and/or the cathode current collector by the pressure applied by the pressing member and made of a material with higher conductivity than the current collectors.

### CLAIM OF PRIORITY

The present application claims priority from Japanese application No. 2006-254564, filed on Sep. 20, 2006, the content of which is incorporated by reference into this application.

### FIELD OF THE INVENTION

The present invention relates to an interconnect architecture for power output from a fuel cell and a technique which improves fuel cell power output.

### BACKGROUND OF THE INVENTION

With the rapid spread of mobile electronic devices such as notebook PCs, cellular phones and mobile audio instruments, demand for smaller size power supplies for driving these devices, longer hours of continuous use and more user-friendliness has been growing. As a power supply which meets this demand, fuel cells which use liquid fuel have been developed as substitutes for conventional secondary batteries which require recharging. Among these fuel cells, a typical fuel cell suitable for use in mobile electronic devices is DMFC (Direct Methanol Fuel Cell), a fuel cell which oxidizes methanol directly.

The above DMFC is expected to provide a higher volume energy density (W/L) and a higher weight energy density (W/kg) than existing secondary batteries. However, one problem with this type of fuel cell is low power density. Efforts toward solving this problem have been made in two fields: one is efforts in the field of materials to increase the power generation ability of a membrane electrode assembly (MEA) constituting a fuel cell and the other is efforts in the field of implementation to reduce various kinds of power loss which occur in modular DMFCs (for example, see JP-A No. 32154/2002).

In the efforts in the field of implementation to improve the power density of fuel cells, the problem explained below exists. DMFC generates electric power on the following principle: a methanol aqueous solution is supplied to the anode (negative electrode) of the MEA and oxygen (air) is supplied to the cathode (positive electrode) of the MEA to induce an electrochemical reaction, forming water as a byproduct on the cathode.

On the other hand, a pair of current collectors for output of the generated electric power to the outside of the DMFC are structured to contact the anode and cathode of the MEA.

Therefore, the current collector on the anode side is immersed in a methanol aqueous solution as a liquid fuel and the current collector on the cathode side is in contact with water as a byproduct, which means that the current collectors must be corrosion-resistant.

However, currently available corrosion-resistant conductive materials which are suitable for the current collectors are low-conductivity materials such as SUS sheet metal and Ti sheet metal or expensive materials such as gold. If a material which is high in conductivity but low in corrosion resistance, such as copper, is used, corrosion occurs with a resulting decline in the output power of the DMFC.

If plural MEAs are combined to increase output power, the joints between current collectors of neighboring MEAs would be made of high-resistance material and a voltage drop would occur in the joints, leading to a large power loss.

One possible approach to reducing such power loss caused by a voltage drop may be to increase the thickness of the current collectors of the DMFC, which, however, contradicts the demand for a compact power supply.

The present invention has an object to solve the above problem and provides a fuel cell which delivers a high power density using corrosion-resistant current collectors.

### SUMMARY OF THE INVENTION

In order to solve the above problem, the present invention provides a fuel cell which includes: a membrane electrode assembly which causes an electrochemical reaction by oxidization of fuel at an anode and reduction of oxygen at a cathode; an anode current collector which lies near the anode of the membrane electrode assembly and collects electrons generated by the electrochemical reaction; a cathode current collector which lies near the cathode of the membrane electrode assembly and collects electrons consumed by the electrochemical reaction; a first end plate which surface-contacts the anode current collector and supplies the fuel to the anode; a second end plate which surface-contacts the cathode current collector and supplies the oxygen to the cathode; a pressing member which applies pressure to the first end plate and the second end plate in a way for the anode current collector and the cathode current collector to hold the membrane electrode assembly between them; and an interconnect which is connected with the anode current collector and/or the cathode current collector by the pressure applied by the pressing member and made of a material with higher conductivity than these current collectors.

Due to the above structure, even when the anode current collector and the cathode current collector are made of a corrosion-resistant material, loss of power generated by electrochemical reaction is suppressed because the interconnect for power output has high conductivity. Therefore, by integrating the membrane electrode assembly (or laminate as a stack of membrane electrode assemblies) and a pair of current collectors for holding it between them, namely the anode current collector and the cathode current collector, into a module and connecting plural such modules by the above interconnect, power output of the fuel cell can be increased without power density deterioration.

Therefore, according to the present invention, a fuel cell with a high power density which uses current collectors with high corrosion resistance is realized.

### BRIEF DESCRIPTION OF THE DRAWINGS

FIG. 1 is an exploded perspective view of a fuel cell according to a first embodiment of the present invention;

FIGS. 2(a) to 2(c) show the fuel cell according to the first embodiment, in which FIG. 2(a) is a perspective view, FIG. 2(b) is a sectional view taken along the line B-B of FIG. 2(a) and FIG. 2(c) is a sectional view taken along the line C-C of FIG. 2(a);

FIGS. 3(a) to 3D are sectional views of interconnect architecture variations for power output to the outside;

FIG. 4 is an exploded perspective view of a fuel cell according to a second embodiment of the present invention;

FIG. 5 is a perspective view of the fuel cell according to the second embodiment; and

FIGS. 6(a) and 6(b) show a fuel cell according to a third embodiment of the present invention, in which FIG. 6(a) is an exploded perspective view of the fuel cell and FIG. 6(b) is an enlarged fragmentary view of a laminate internal structure.

### DETAILED DESCRIPTION OF THE PREFERRED EMBODIMENTS

### First Embodiment

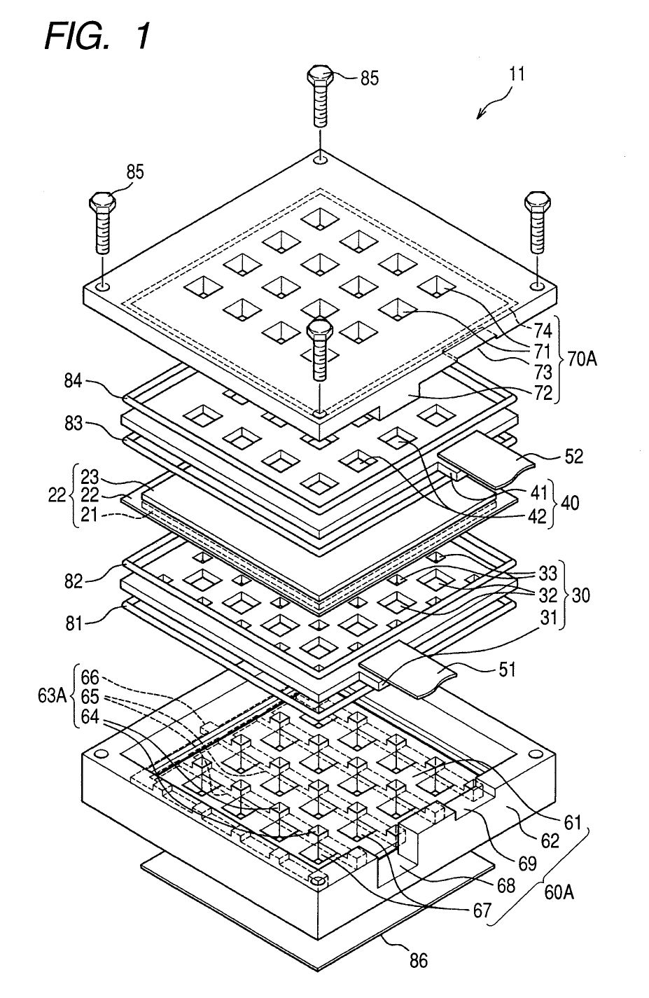

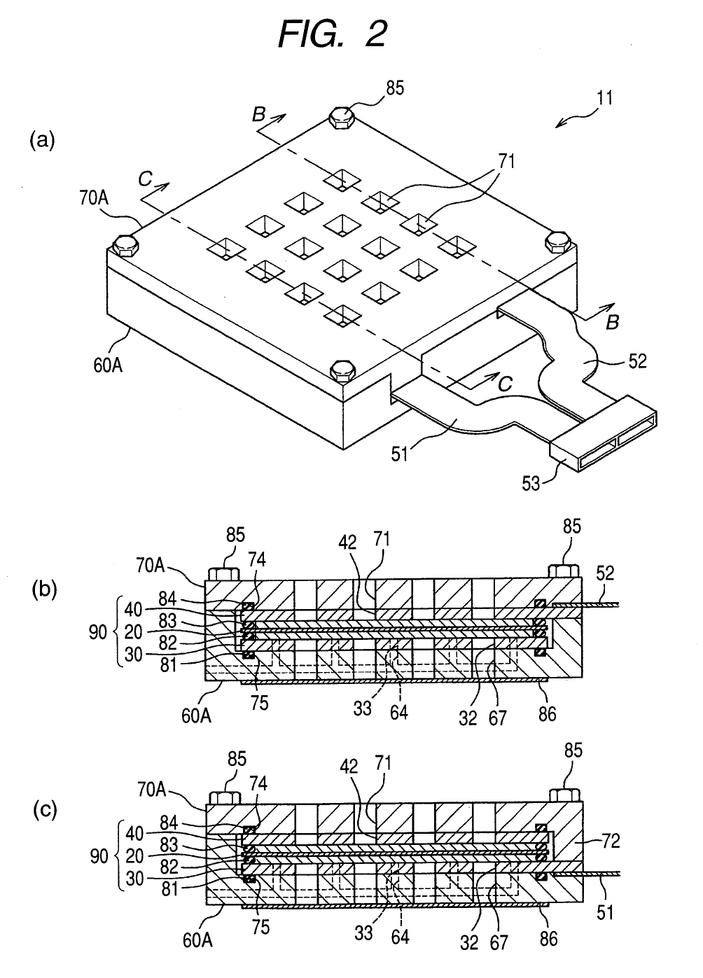

Next, a fuel cell according to the first embodiment of the present invention will be described referring to FIGS. 1 to 3(a)s illustrated in FIG. 1 (also see FIG. 2(a)s appropriate), a fuel cell 11 according to this embodiment includes: a membrane electrode assembly 20, an anode current collector 30, a cathode current collector 40, interconnects (anode interconnect 51, cathode interconnect 52), a first end plate 60A, a second end plate 70A, sealing members 81, 82, 83, 84 and pressing members 5.

In the membrane electrode assembly (MEA) 20, an electrolyte membrane 22 is held between the anode 21 and the cathode 23(a)nd fuel is oxidized at the anode 21 and oxygen is reduced at the cathode 23 to cause an electrochemical reaction.

Here, one side of the anode 21 is in contact with the electrolyte membrane 22(a)nd the other side is in contact with the anode current collector 30. The anode 21 is a mixture of catalyst as ruthenium and platinum alloy particles and carbon powder carrying this catalyst. When a liquid fuel (methanol and water) is supplied to the anode 21 through fuel path holes 33 in the anode current collector 30, the fuel is oxidized to generate hydrogen ions and electrons in accordance with Formula (1) (shown below). The generated electrons move to the anode current collector 30, which will be explained later, and become ready to be conducted to an external load. Carbon dioxide as a byproduct gas flows through exhaust holes 32 in the anode current collector 30 and exhaust path holes 67 in the first end plate 60A to the outside.

The electrolyte membrane 22 is made of, for example, polyperfluoro sulfonic acid resin, specifically Nafion (registered trademark), Aciplex (registered trademark) or the like. The electrolyte membrane 22 has a function to transport the hydrogen ions generated at the anode 21 to the cathode 23(b)ut not to transport electros.

Here, one side of the anode 23 is in contact with the electrolyte membrane 22(a)nd the other side is in contact with the cathode current collector 40. The cathode 23 is a mixture of catalyst as platinum particles and carbon powder carrying this catalyst. When electrons are supplied to the cathode 23 through the cathode current collector 40, oxygen coming through oxygen path holes 42(a)fter being reduced, reacts with hydrogen ions transported by the electrolyte membrane 22 to form water in accordance with Formula (2). The water, a byproduct, is discharged through the oxygen path holes 42 in the cathode current collector 40 and oxygen supply holes 71 in the second end plate 70A to the outside.

Thus, in the membrane electrode assembly 20, methanol as fuel and water react electrochemically at 1:1 mole ratio to generate power in accordance with Formula (1) and Formula (2) and as a consequence, carbon dioxide as a byproduct gas is formed at the cathode 21 and water as a byproduct is formed at the cathode 23.

Anode 21: CH₃OH+H₂O→CO₂ +6H⁺+6e⁻ (1)

Cathode 23: 3/2O₂+6H⁺+6e⁻→3H₂O (2)

Overall reaction: CH₃OH+3/2O₂→CO₂+2H₂O (3)

The anode current collector 30 includes a contact piece 31, exhaust holes 32(a)nd fuel path holes 33(a)nd lies near the anode 21 of the membrane electrode assembly 20 so as to collect the electrons generated by the above electrochemical reaction. The anode current collector 30 is thus electrically conductive and should be corrosion-resistant to the liquid fuel which it always contacts; concretely it is made of SUS sheet metal or Ti sheet metal.

The contact piece 31, protruding from part of the peripheral edge of the anode current collector 30, moves the electrons generated by electrochemical reaction to an external load thorough the anode interconnect 51 connected with it. The contact piece 31 is so shaped as to fit and touch the inside of an anode outlet 68 of the first end plate 60A which will be explained later. The contact piece 31 and the anode interconnect 51 are connected with each other by a pressure to the area where they overlap, which is applied by the anode outlet 68 and an anode pressing portion 72.

The exhaust holes 32(a)re holes thorough which the byproduct gas generated in the membrane electrode assembly 20 by electrochemical reaction (carbon dioxide) is discharged. The byproduct gas which has passed through these exhaust holes 32 flows through the exhaust path holes 67 in the first end plate 60A and through a gas transmission membrane 86 to the outside.

A plurality of fuel path holes 33(a)re provided penetrating the anode current collector 30 surface. Each of the fuel path holes 33 is disposed so that one opening end of it contacts the anode 21 and the other opening end communicates with a fuel supply hole 64 in the first end plate 60A. The fuel path holes 33 thus structured feed the fuel supplied from the first end plate 60A through the anode current collector 30 to the anode 21.

The cathode current collector 40 includes a contact piece 41 and oxygen path holes 42(a)nd lies near the cathode 23 of the membrane electrode assembly 20 so as to collect the electrons consumed by electrochemical reaction from the external load. The cathode current collector 40 is thus electrically conductive and should be corrosion-resistant to the water as a byproduct with which it always contacts; concretely it is made of SUS sheet metal, Ti sheet metal, sheet carbon or any of these materials with a good conductor coating (gold coating) thereon.

The contact piece 41, protruding from part of the peripheral edge of the cathode current collector 40, is a part at which the electrons collected from the external load reaches thorough the cathode interconnect 52(c)onnected with it. The contact piece 41 is so shaped as to fit and touch the inside of a cathode outlet 69 of the first end plate 60A which will be explained later. The contact piece 41 and the cathode interconnect 52(a)re connected with each other by a pressure to the area where they overlap, which is applied by the cathode outlet 69 and a cathode pressing portion 73.

A plurality of oxygen path holes 42(a)re provided penetrating the cathode current collector 40 surface. The oxygen path holes 42(a)re passages for the oxygen (air) which is introduced from the atmosphere into oxygen supply holes 71 in the second end plate 70A and consumed in the membrane electrode assembly 20 by electrochemical reaction. The oxygen path holes 42(a)lso serve as passages for the water which is formed by reduction of the oxygen thus consumed and is discharged to the outside.

Made of a material with higher conductivity than the anode current collector 30 (for example, copper), the anode interconnect 51 is connected with the contact piece 31 of the anode current collector 30 by the pressure applied by pressing members 85, which will be explained later, and outputs the electric power generated by electrochemical reaction to the external load.

Made of a material with higher conductivity than the cathode current collector 40 (for example, copper), the cathode interconnect 52 is connected with the contact piece 41 of the cathode current collector 40 by the pressure applied by the pressing members 85, which will be explained later, and outputs the electric power generated by electrochemical reaction to the external load.

These interconnects (anode interconnect 51 and cathode interconnect 52) may be concretely flexible printed circuit boards (FPC) consisting of printed circuits of good conductor foil (copper foil) on flexible insulating resin sheets in which the top surfaces of the printed interconnects 51 and 52(a)re covered by similar flexible insulating resin sheets. Alternatively they may be flexible flat cables (FFC) prepared by covering the outer surfaces of good conductor wires (copper wires) by flexible insulating resin and bundling several such wires arranged in a row.

Although the interconnects 51 and 52(a)re not limited to FPC or FFC as mentioned above, it is desirable that they be flat because their contact resistance with the current collectors (anode current collector 30 and cathode current collector 40) should be minimized.

Furthermore, in order to ensure that the interconnect 51 (52) is electrically isolated from the end plate 60A (70A), its surface supposed to contact the end plate 60A (70A) should be insulated. On the other hand, in order to reduce contact resistance between the current collector 51 (52) and the interconnect 51 (52), it is desirable that the side face of the current collector 30 (40) be gold-coated.

The other ends of the anode interconnect 51 and the cathode interconnect 52 (not shown in FIG. 1) are joined to a connection terminal 53 shown in FIG. 2(a), thorough which they are connected to an external load (not shown) such as a mobile electronic device.

Since these interconnects 51 and 52 have at least higher conductivity than the current collectors 30 and 40, they prevent a voltage drop in the route for supplying power from the current collectors 30 and 40 to the mobile electronic device, thereby contributing to increase in the power output of the fuel cell 11.

For the purpose of confirming the above effect of this embodiment, a simulation test was conducted to compare this embodiment and a comparative example where the embodiment was a fuel cell 11 structured as shown in FIG. 2(a) using current collectors 30 and 40 made of 0.3 mm thick sheet titanium while the comparative example was a fuel cell which uses current collectors 30 and 40 made of 0.3 mm thick sheet titanium similarly and has a terminal protruding approx. 5 mm outside end plates 60 and 70, as an extension from the current collectors 30 and 40.

The test result has demonstrated that the fuel cell 11 as the embodiment is 7.4% lower in overall resistance than the comparative example and thus effective in reducing power loss. Although the thickness of the current collectors 30 and 40 was 0.3 mm in this simulation test, a similar effect has been achieved regardless of the thickness.

The form (connection terminal 53) of the other ends of the anode interconnect 51 and cathode interconnect 52(a)s illustrated in FIG. 2(a) is just one example. The other ends may be in another form as follows (not shown): the anode interconnect 51 and the cathode interconnect 52 have connection terminals (not shown) separately and the connection terminal of the anode interconnect 51 is connected with that of the cathode interconnect 52 so as to enable connection of plural modular fuel cells.

Another variation is that either the anode interconnect 51 or the cathode interconnect 52 is only provided and the connection terminal of the only interconnect and the connection terminal (not shown) directly joined to the current collector without an interconnect are connected between plural modular fuel cells.

Even when plural modular fuel cells are connected in this way, power output of the fuel cells 11 is increased without power density deterioration because the interconnects 51 and 52 have higher conductivity than the current collectors 30 and 40.

The first end plate 60A includes a bottom face 61 and side faces 62 extending vertically from the outer edge of the bottom face 61 and it surface-contacts the anode current collector 30 on the bottom face 61 and supplies fuel to the anode 21. In addition, the first end plate 60A itself is an insulator or its contact surface is covered by an insulating coating so that the anode current collector 30 which contacts it is kept electrically isolated.

The bottom face 61 of the first end plate 60A has a fuel supply channel 63(a) and exhaust path holes 67. The fuel supply channel 63(a) includes: plural fuel supply holes 64 in the bottom face 61 of the first end plate 60A which are open to the anode current collector 30; communication paths 65 which communicate with all these fuel supply holes 64; and a fuel injection port 66(a)s an extension of the communication paths 65, which is open to the outside of the first end plate 60A.

The fuel injection port 66 is connected to a fuel tank (not shown) which stores fuel. As fuel is fed from the fuel tank to the fuel injection port 66(a)t a prescribed pressure, the fuel is supplied from the plural fuel supply holes 64 to the anode 21 along the communication paths 65 at a uniform pressure.

This embodiment uses the fuel supply channel 63(a) as a means to supply fuel to the anode 21 as described above; however the means is not limited thereto. Another possible approach is that liquid fuel is held in a continuous space which replaces all the communication paths 65 and drilled holes as fuel supply holes 64.

The anode outlet 68 and cathode outlet 69 are provided in a side face 62 of the first end plate 60A.

The anode outlet 68, in which the contact piece 31 of the anode current collector 30 is to lie, is designed to engage with the anode pressing portion 72 when the second end plate 70A is mounted (see FIG. 2(a)) . With the contact piece 31 overlapping part of the end of the anode interconnect 51, the anode outlet 68 and the anode pressing portion 72(a)re engaged. This presses the contact piece 31 and part of the end of the anode interconnect 51 and connects them electrically adequately.

The cathode outlet 69, in which the contact piece 41 of the cathode current collector 40 is to lie, is designed to face the cathode pressing portion 73 when the second end plate 70A is mounted (see FIG. 2(a)). With the contact piece 41 overlapping part of the end of the cathode interconnect 52, the first end plate 60A and the second end plate 70A are joined. This presses the contact piece 41 and part of the end of the cathode interconnect 52(a)nd connects them electrically adequately.

The exhaust path holes 67 penetrate the bottom face 61 of the first end plate 60A and their positions coincide with the positions of the exhaust holes 32 in the anode current collector 30. The exhaust path holes 67 are intended to discharge carbon dioxide as a byproduct gas from electrochemical reaction to the outside.

The second end plate 70A includes oxygen supply holes 71 and an anode pressing portion 72(a)nd a cathode pressing portion 73(a)nd surface-contacts the cathode current collector 40 on one side of it where the oxygen supply holes 71 are open, and supplies oxygen (air) to the cathode 23. In addition, the second end plate 70A itself is an insulator or its contact surface is covered by an insulating coating so that the cathode current collector 40 which contacts it is kept electrically isolated.

Next, sealing members 81, 82, 83(a)nd 84 will be described referring to FIGS. 1 and FIG. 2(b).

The first sealing member 81 lies in a packing groove 75 carved in the first end plate 60A in a way to surround the fuel supply holes 64, preventing the liquid fuel from leaking along the surface of contact between the anode current collector 30 and the first end plate 60A.

The second sealing member 82 lies between the electrolyte membrane 22(a)nd the anode current collector 30 in a way to surround the anode 21, preventing the liquid fuel from leaking outside the area which it surrounds. The anode interconnect 51 and the contact piece 31 of the anode current collector 30 contact each other outside the area which the second sealing member 82 surrounds. This prevents the liquid fuel from leaking, adhering to the anode interconnect 51 and causing corrosion.

The third sealing member 83 lies between the electrolyte membrane 22(a)nd the cathode current collector 40 in a way to surround the cathode 23, preventing accidentally leaked liquid fuel from entering the cathode 23.

The purpose of preventing liquid fuel leakage from the anode 21 and preventing liquid fuel entry into the cathode 23(a)s mentioned above is to prevent the activity of the cathode 23 from declining and thereby prevent deterioration in power generation efficiency.

The fourth sealing member 84 lies in a packing groove 74 carved in the second end plate 70A in a way to surround the oxygen supply holes 71, preventing byproduct water from leaking along the surface of contact between the cathode current collector 40 and the second end plate 70A. Besides, the cathode interconnect 52(a)nd the contact piece 41 of the cathode current collector 40 contact each other outside the area which the fourth sealing member 84 surrounds. This prevents the water from leaking, adhering to the cathode interconnect 52(a)nd causing corrosion.

For example, the pressing members 85 are parts which join the first end plate 60A and the second end plate 70A by helically fastening them at the four corners of the fuel cell 11 as shown. In other words, they have a function to apply pressure to the first end plate 60A and the second end plate 70A in a way for the membrane electrode assembly 20 to be held between the anode current collector 30 and the cathode current collector 40 so that the laminate composed of the membrane electrode assembly 20, anode current collector 30 and cathode current collector 40 is held in the space formed by the first end plate 60 and the second end plate 70. The pressure applied by the pressing members 85 presses the interconnects 51 and 52(a)nd the current collectors 41 and 51 and reduces the contact resistance to ensure good electrical connection.

The pressing members 85 as shown are just an example and anything that performs the above function may be used instead of them. For instance, an adhesive agent which joins the first end plate 60A and second end plate 70A on the plane of contact between them may be used instead.

The gas transmission membrane 86 lies on the outer openings of the exhaust path holes 67. The gas transmission membrane 86 transmits the byproduct gas (carbon dioxide) generated by electrochemical reaction but does not transmit fuel. The material of the gas transmission membrane with such gas permeability 86 may be woven cloth, non-woven cloth, net, felt or the like: for example, continuously porous polytetrafluoroethylene (expanded PTFE) or as a commercial product, Gore-Tex (registered trademark).

The gas transmission membrane 86 hermetically seals the openings of the exhaust holes 32(a)nd the exhaust path holes 67 so as to prevent leakage of the liquid fuel staying in these holes while allowing only the byproduct gas to be discharged to the outside.

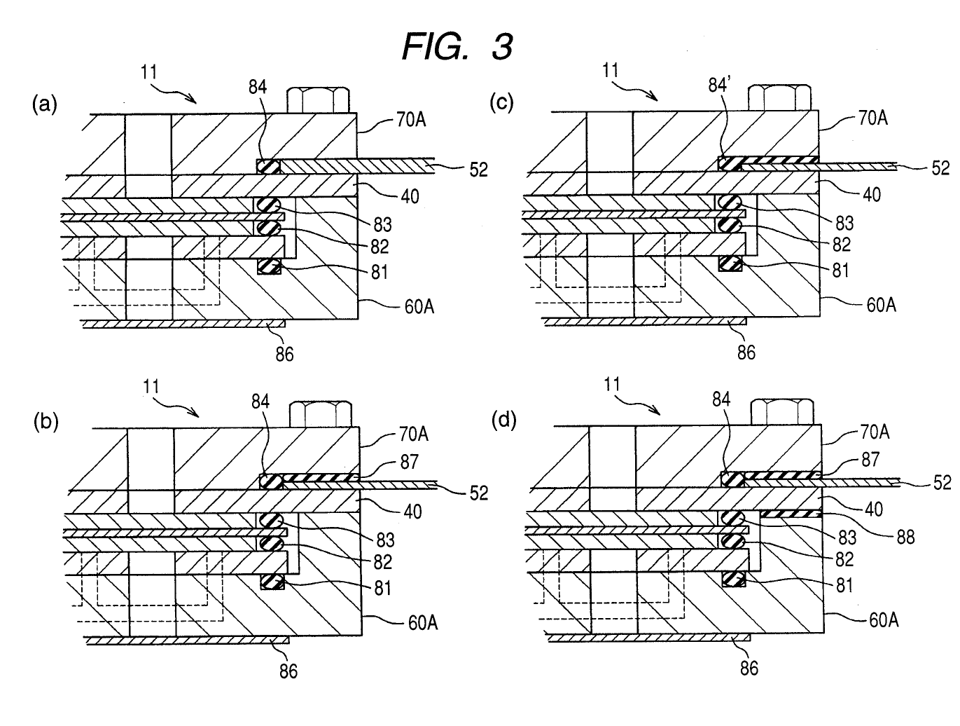

Next, a variation of the structure in which the ends of the interconnects (anode interconnect 51 and cathode interconnect 52) are connected with the current collectors (anode current collector 30 and cathode current collector 40) will be described referring to FIGS. 3.

FIG. 3(a) is an enlarged view of the vicinity of the end of the cathode interconnect 52 shown in FIG. 2(b) . FIG. 3(b) shows that an insulating first elastic member 87 lies between the second end plate 70A and the cathode interconnect 52.

The first elastic member 87 further conveys the pressure conveyed from the second end plate 70A to connect the cathode interconnect 52 to the cathode current collector 40.

FIG. 3(c) shows the use of a fourth sealing member 84′, an integrated combination of the first elastic member 87 and the fourth sealing member 84.

FIG. 3D shows that an insulating second elastic member 88 further lies between the first end plate 60A and the cathode current collector 40.

The second elastic member 88 further conveys the pressure conveyed from the first end plate 60A and lies on the face of the cathode current collector 40 which is opposite to its face which is connected with the cathode interconnect 52.

The first elastic member 87 and the second elastic member 88 improve electrical connection by contact between the current collector 40 (30) and the interconnect 52 (51).

In addition, the dimensional accuracy requirement for other parts (for example, the cathode outlet 69, cathode pressing portion 73(a)nd the like) which contact the interconnects 51 and 52 through these elastic members 87 and 88 is relaxed, which contributes to yield improvement in assembling fuel cells.

In the variations shown in FIGS. 3, the second end plate 70A and the cathode current collector 40 hold the cathode interconnect 52(b)etween them; however the invention is not limited thereto. It is also possible that the first end plate 60A and the cathode current collector 40 hold the cathode interconnect 52(b)etween them or the second end plate 70A and the anode current collector 30 hold the anode interconnect 51 between them or the first end plate 60A and the anode current collector 30 hold the anode interconnect 51 between them.

### Second Embodiment

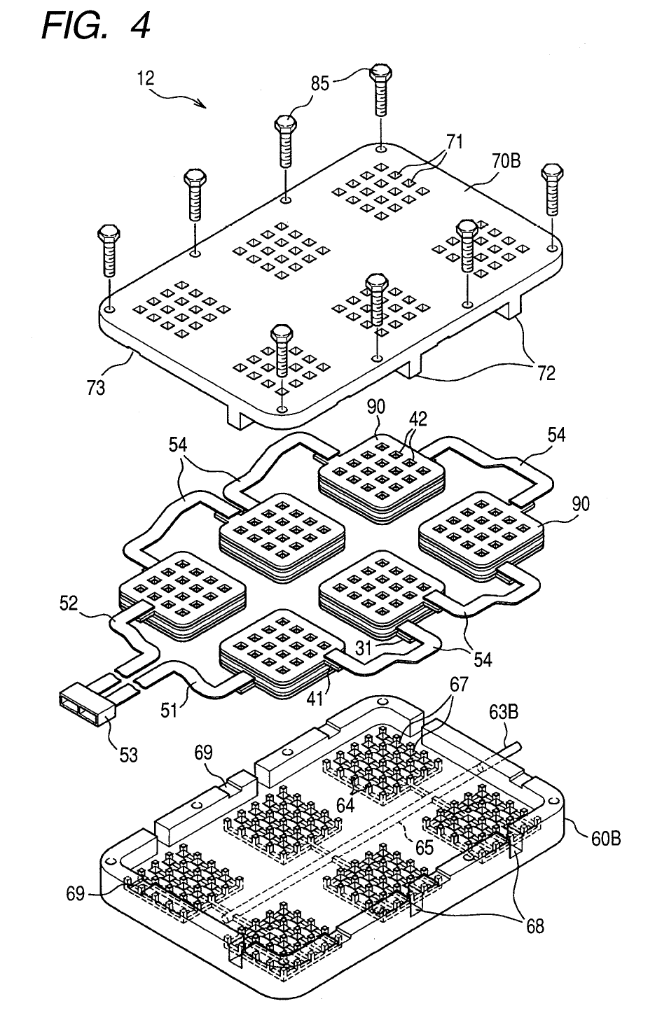

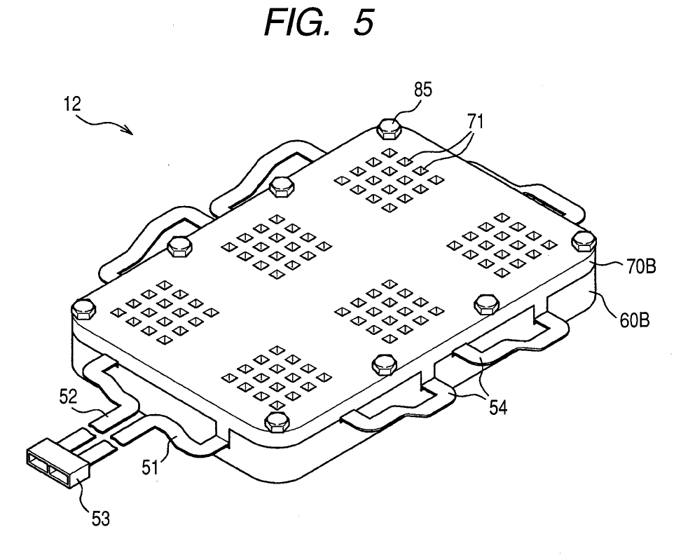

Next, a fuel cell according to a second embodiment of the present invention will be described referring to FIGS. 4 and 5. In the explanation given below, the combination of the membrane electrode assembly 20, anode current collector 30 and cathode current collector 40 which has been prepared in advance as shown in FIG. 2(b) is referred to as an MEA unit 90.

In the case of DMFC, the voltage of a single MEA unit 90 is as low as 0.8 V or less and therefore plural MEA units 90 are usually connected in series to make up a fuel cell.

A fuel cell 12(a)s shown in FIGS. 4 and 5 uses plural MEA units 90 connected in series to increase power output.

The elements of the fuel cell 12 shown in FIG. 4 which have the same functions as those described above are designated by the same reference numerals as in FIG. 1 and in this specification their descriptions are not repeated below. Elements which are different in form but similar in functionality are designated by the same reference numerals accompanied by letter B (for an element designated by a reference numeral accompanied by letter B, refer to the description of the element designated by the same reference numeral accompanied by letter A as necessary).

The first end plate 60B incorporates plural MEA units 90 connected in series (six units in the case shown in the figure). The first end plate 60B has a fuel supply channel 63(b) and exhaust path holes 67 in a way to correspond to the positions of the MEA units 90.

On the side faces of the first end plate 60B, cathode outlets 69 and anode outlets 68 are provided in positions corresponding to the cathode current collector contact pieces 41 and anode current collector contact pieces 31 of the MEA units 90, in the form of cutouts.

On the peripheral edges of the second end plate 70B, cathode pressing portions 73(a)nd anode pressing portions 72(a)re provided in positions corresponding to the cathode outlets 69 and anode outlets 68 respectively. When assembled (see FIG. 5), each cathode pressing portion 73 presses the area where a cathode current collector contact piece 41 and one end of a coupling interconnect 54 overlap, so that they are electrically connected. Also, when assembled (see FIG. 5), each anode pressing portion 72 presses the area where an anode current collector contact piece 31 and the other end of the coupling interconnect 54 overlap, so that they are electrically connected.

Since the coupling interconnect 54 which couples MEA units 90 is laid outside the first end plate 60B and second end plate 70B as illustrated in FIG. 4, it couldn't corrode due to adhesion of liquid fuel or byproduct water.

Thus, the anode current collector 30 of one of neighboring MEA units 90 and the cathode current collector 40 of the other MEA unit are coupled to connect the units; and neighboring units are connected in this way successively like e a chain and the anode interconnect 51 and cathode interconnect 52 (a)re pulled out from the MEA units 90 located at the ends of this chain so that output power is increased.

When many MEA units are connected in series in this way, the prior art has the problem of increased electric resistance in the area of joint between neighboring units; this embodiment solves this problem by using the highly conductive coupling interconnect 54.

Although sealing members are not shown in FIG. 4, each MEA unit 90 has sealing members located in a way to surround the periphery of the unit 90 on its both sides. This prevents liquid fuel or byproduct water from leaking from gaps in contact areas on both sides of the MEA unit 90, adhering to the anode interconnect 51, cathode interconnect 52 or coupling interconnect 54, and causing corrosion.

### Third Embodiment

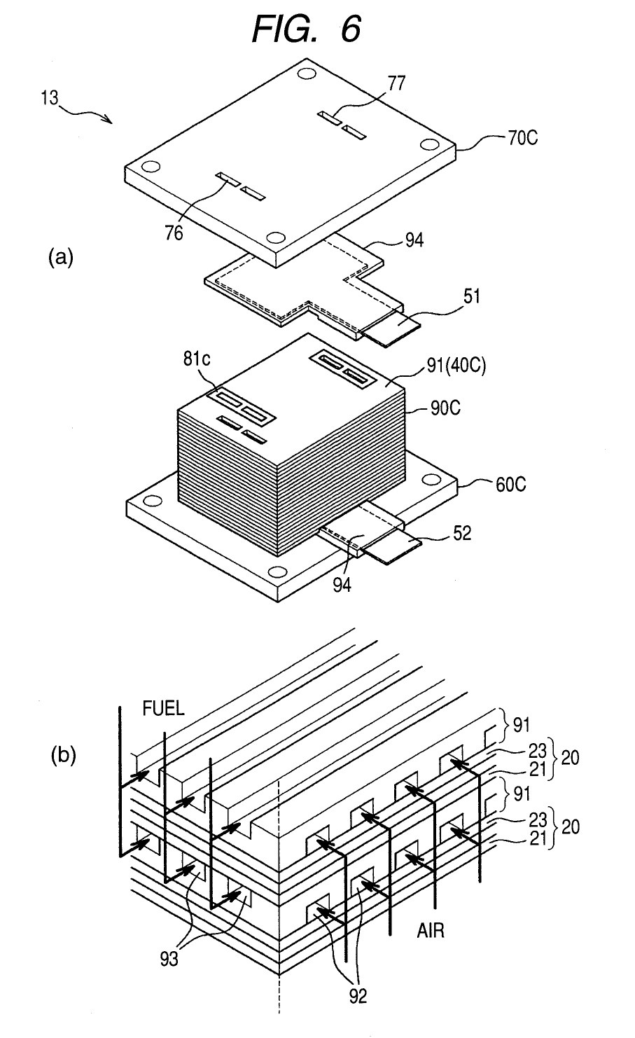

Next, a fuel cell according to a third embodiment of the present invention will be described referring to FIGS. 6.

This embodiment concerns a laminated fuel cell 13 which features a stack of membrane electrode assemblies 20. The fuel cell 13 includes a cathode interconnect 51, an anode interconnect 52(a) first end plate 60C, a second end plate 70C, and an MEA unit 90C as shown in FIG. 6(a).

In this fuel cell 13, the separator 91 (explained later) of the MEA unit 90C which is nearest to the second end plate 70C functions as a cathode current collector 40C and the separator 91 (hidden in the figure) of the MEA unit 90C which is nearest to the first end plate 60C functions as an anode current collector.

The first end plate 60C lies on the side of the anode interconnect 52 which is opposite to its side which contacts the MEA unit 90C. The second end plate 70C lies on the side of the cathode interconnect 51 which is opposite to its side which contacts the MEA unit 90C. The first end plate 60C and the second end plate 70C hold the MEA unit 90C between them by pressure applying means (not shown).

The second end plate 70C has: a fuel injection port 76 into which liquid fuel is poured; and a fuel discharge port 77 through which the fuel circulated from the fuel injection port 76 through fuel paths 93 (see FIG. 6(b)) to the MEA unit 90C is discharged. In addition, sealing members 81C which prevent liquid fuel leakage are provided around the fuel injection port 76(a)nd the fuel discharge port 77 in the boundary between the second end plate 70C and the MEA unit 90C.

The first end plate 60C has: an oxygen feed port (hidden in the figure) through which oxygen is fed; and an oxygen discharge port through which the oxygen (air) circulated from the oxygen feed port through oxygen paths 92 (see FIG. 6(b)) to the MEA unit 90C is discharged.

Although the routes of liquid fuel and oxygen (air) circulation are partially shown in FIG. 6(b), concretely a known circulation arrangement is employed.

The MEA unit 90C is a laminate consisting of plural membrane electrode assemblies 20 and separators 91 which are alternately stacked, as illustrated in FIG. 6(b).

Each separator 91 has, on its first face, fuel paths 93 through which liquid fuel passes and, on its second face, oxygen paths 92 through which oxygen (air) passes. The separator 91 contacts the anode 21 of a membrane electrode assembly 20 on the first face and contacts the cathode 23 of another membrane electrode assembly 20 on the second face. Thus structured, the separator 91 supplies liquid fuel to the anode 21 and supplies oxygen to the cathode 23.

As illustrated in the exploded perspective view of FIG. 6(a), the main portion of the cathode interconnect 51 is held between the second end plate 70C and the MEA unit 90C with the lead extending outside. The cathode interconnect 51 is covered by an insulating member 94 which blocks electrical conduction but its portion to be connected with the MEA unit 90C and the end of the lead extending outside are not covered by the insulating member 94.

Thus structured, the cathode interconnect 51 is connected with the cathode current collector 40C by the pressure applied to the first end plate 60C and the second end plate 70C so as to hold the MEA unit between them, and moves electrons consumed by electrochemical reaction from an external load.

The structure of the anode interconnect 52 is similar to that of the cathode interconnect 51 though only its lead is shown in FIG. 6(a). Thus structured, the anode interconnect 52 is connected with the anode current collector by the pressure applied to the first end plate 60C and the second end plate 70C so as to hold the MEA unit between them, and moves electrons generated by electrochemical reaction to the external load.

As described above, the leads of the cathode interconnect 51 and anode interconnect 52, extending outside the fuel cell 13(a)re connected to the external load so that electric power is supplied from the fuel cell 13 to the external load.

What is claimed is:

1. A fuel cell comprising:
a membrane electrode assembly which causes an electrochemical reaction by oxidization of fuel at an anode and reduction of oxygen at a cathode;
an anode current collector which lies near the anode of the membrane electrode assembly and collects electrons generated by the electrochemical reaction;
a cathode current collector which lies near the cathode of the membrane electrode assembly and collects electrons consumed by the electrochemical reaction;
a first end plate which surface-contacts the anode current collector and supplies the fuel to the anode;
a second end plate which surface-contacts the cathode current collector and supplies the oxygen to the cathode;
a pressing member which applies pressure to the first end plate and the second end plate in a way for the anode current collector and the cathode current collector to hold the membrane electrode assembly between them; and
an interconnect which is connected with the anode current collector and/or the cathode current collector by the pressure applied by the pressing member and made of a material with higher conductivity than these current collectors.

2. The fuel cell according to claim 1,
wherein a sealing member for preventing liquid leakage lies on at least a contact face on which the interconnect is connected, among the faces of the anode current collector and/or the cathode current collector; and
wherein the connection of the interconnect is made outside an area of the contact surface surrounded by the sealing member.

3. The fuel cell according to claim 1 or 2, further comprising:
a first elastic member which further conveys the pressure conveyed from the first end plate and/or the second end plate to connect the interconnect to the anode current collector and/or the cathode current collector and has an insulating property.

4. The fuel cell according to any of claims 1 to 3, further comprising:
a second elastic member which further conveys the pressure conveyed from the first end plate and/or the second end plate and lies on a face of the anode current collector and/or the cathode current collector which is opposite to a face on which the interconnect is connected, and has an insulating property.

5. A fuel cell comprising:
a membrane electrode assembly which causes an electrochemical reaction by oxidization of fuel at an anode and reduction of oxygen at a cathode;
separators which are arranged alternately with a plurality of the membrane electrode assemblies to make up a laminate and supply the fuel to the anode and supply the oxygen to the cathode;
an anode current collector which lies on one end face of the laminate and collects electrons generated by the electrochemical reaction
a cathode current collector which lies on the other end face of the laminate and collects electrons consumed by the electrochemical reaction;
a first end plate and a second end plate which hold the laminate between them; and
an interconnect which is connected with the anode current collector and/or the cathode current collector by the pressure applied to the first end plate and the second end plate to hold the laminate and outputs electric power generated by the electrochemical reaction.

6. The fuel cell according to any of claims 1 to 5,
wherein the interconnect is a flexible printed circuit board or flexible flat cable.

7. The fuel cell according to any of claims 1 to 6,
wherein an area of contact of the interconnect with the first end plate or the second end plate is insulated.
